(19) United States
(12) Patent Application Publication
(10) Pub. No.: US 2025/0383584 A1
(43) Pub. Date: Dec. 18, 2025

(54) SYSTEMS AND METHODS FOR SHIELDING VEHICLE CAMERA

(71) Applicant: Ford Global Technologies, LLC, Dearborn, MI (US)

(72) Inventors: Michael Robertson, West Bloomfield, MI (US); Aaron Bradley Johnson, Allen Park, MI (US); Venkatesh Krishnan, Canton, MI (US); Segundo Baldovino, Novi, MI (US)

(73) Assignee: Ford Global Technologies, LLC, Dearborn, MI (US)

(21) Appl. No.: 18/741,338

(22) Filed: Jun. 12, 2024

(51) Int. Cl. G03B 11/04; B60R 1/23; B60R 11/00; B60R 11/04; B60S 1/54; H04N 23/75

(52) U.S. Cl. CPC G03B 11/045; B60R 1/23; B60R 11/04; B60S 1/54; H04N 23/75; B60R 2011/0085; B60R 2011/0092

(57) ABSTRACT

A vehicle including a housing, a camera and a shield is disclosed. The camera may be disposed in the housing, and may include a lens that may face away from a housing interior portion. The shield may be configured to move between a retracted position and an extended position. The shield may protect/shield the lens from glare in the extended position, and may not shield the lens in the retracted position. The shield may include a gutter structure disposed at a shield distal edge, which may be configured to protect the lens from rain water in the extended position. A gutter structure plane may be perpendicular to a shield plane.

### FIELD

The present disclosure relates to systems and methods for shielding a vehicle camera from glare, rain or debris.

### BACKGROUND

Vehicle exterior cameras are used to capture surrounding images, which are displayed to a vehicle driver for ease of driving or used by vehicle systems to enable autonomous vehicle movement. It is known that camera's field of view (FOV) may get affected when light from an incoming vehicle or sun rays fall on the camera's lens. The camera's FOV may further get affected when rain, snow, dust, debris, etc. fall on the camera's lens. Such instances may result in suboptimal image capture by the vehicle camera, which in turn may cause inconvenience to the driver and/or affect the vehicle's autonomous movement.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a vehicle with an example first camera system in accordance with the present disclosure.

FIG. 2 depicts a cross-sectional view of the first camera system in accordance with the present disclosure.

FIG. 3 depicts a cross-sectional view of a second camera system in accordance with the present disclosure.

FIG. 4A depicts a cross-sectional view of a shield of the second camera system in a partially extended position in accordance with the present disclosure.

FIG. 4B depicts a cross-sectional view of the shield of the second camera system in a fully extended position in accordance with the present disclosure.

FIG. 5 depicts an isometric view of a third camera system in accordance with the present disclosure.

FIG. 6 depicts a schematic of a vehicle camera in accordance with the present disclosure.

FIG. 7 depicts a flow diagram of an example method to shield a vehicle camera in accordance with the present disclosure.

### DETAILED DESCRIPTION

### Overview

The present disclosure describes a system and method to shield a vehicle camera from glare caused by light beams from incoming vehicles, bright sunlight, etc. The system may be part of a vehicle, and may include a housing, the camera, and a shield. The camera may be disposed in the housing, and may include a lens that may face away from a housing interior portion. The shield may be configured to move between a retracted position, a partially extended position and a fully extended position, based on command signals obtained from a vehicle processor. The shield may be stowed inside the housing interior portion in the retracted position, and may extend away from the housing interior portion in the partially or fully extended position. The shield may protect/shield the lens from glare when the shield may be in the partially or fully extended position.

In some aspects, the processor may cause a shield movement to the retracted position, the partially extended position or the fully extended position based on user inputs obtained from a vehicle driver. In other aspects, the processor may cause the shield movement based on sensor inputs obtained a vehicle sensor unit, which may be configured to detect an extent of glare on the lens. The processor may cause the shield movement to the partially or fully extended position when the extent of glare may be greater than a predefined threshold. In an exemplary aspect, an extent of shield movement to the partially extended position or the fully extended position may be based on the extent of glare detected on the lens.

In further aspects, the shield may include a gutter structure disposed at a shield distal edge. The gutter structure may be configured to protect the lens/camera from rain water when the shield may be in the extended position (e.g., the fully extended position). In this aspect, the processor may cause the shield to move to the fully extended position when the processor detects a rain presence (based on sensor inputs obtained from the sensor unit), thereby protecting the lens/camera from rain water.

In additional aspects, the shield may include a first portion and a second portion that may be pivotally connected with each other via a hinge. The first portion may be configured to rotate relative to the second portion via the hinge. The first portion may extend away from the housing interior portion (while the second portion may stay inside the housing interior portion) and be disposed above the lens and perpendicular to a lens plane, when the shield may be in the partially extended position. In the partially extended position, the shield may protect the lens from glare and/or rain.

The first portion may extend away from the housing interior portion (while the second portion may stay inside the housing interior portion) and be disposed over the lens and parallel to the lens plane, when the shield may be in the fully extended position. In the fully extended position, the shield may protect the lens from dust, debris, mud, etc. The processor may cause the shield to move to the fully extended position when such external elements may be detected on the lens, and/or the vehicle may be operating in an off-road mode.

The system may further include a washer that may be configured to blow air towards the lens, when the washer receives an activation signal from the processor. The processor may transmit the activation signal to the washer when dust, debris, mud, etc. may be detected on the lens or when the lens may be wet.

In yet another aspect, the processor may cause the camera to move partially/slightly into the housing interior portion when the extent of glare on the lens may be greater than the predefined threshold or responsive to detecting the rain presence.

In some aspects, the camera may further include an image sensor that may be disposed a predefined distance away from the lens. The processor may be additionally configured to move the image sensor away from the lens when the extent of glare on the lens may be greater than the predefined threshold.

The present disclosure discloses a system and method to shield a vehicle camera from glare, rain and/or debris. By shielding the camera from glare, the system facilitates the camera in capturing high-quality images. The system does not require any external hardware, and is part of the vehicle. Further, the system operates automatically/autonomously whenever glare, rainwater and/or debris is detected at the camera, thereby considerably enhancing driver's convenience. These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

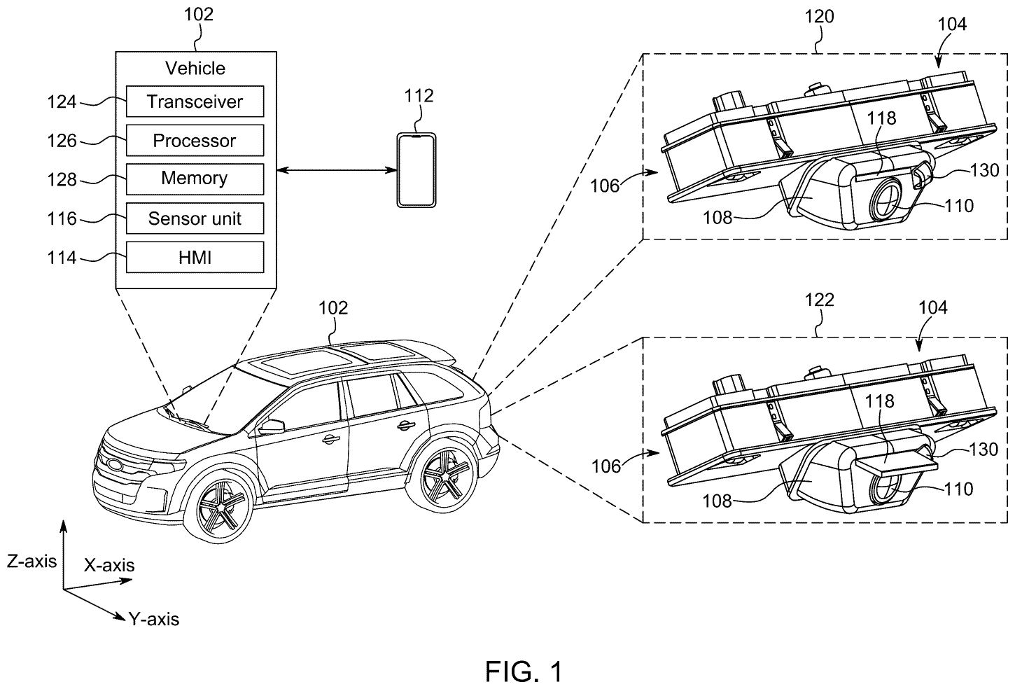

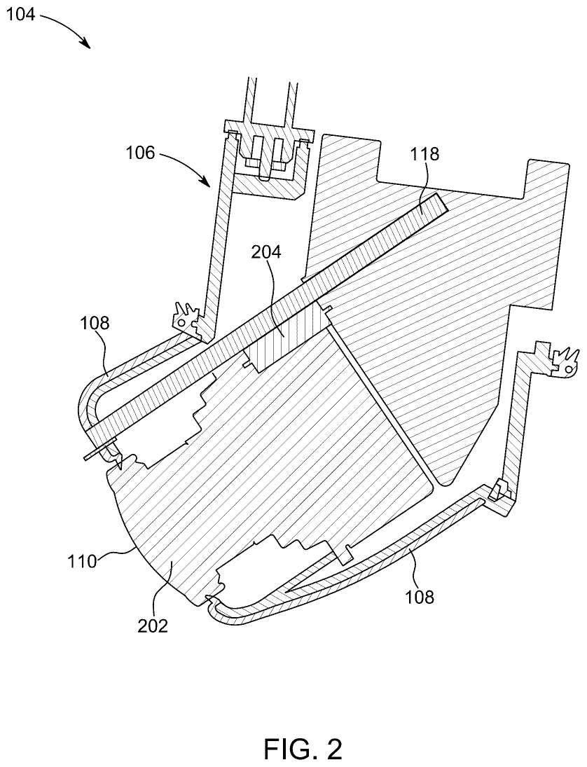

FIG. 1 depicts a vehicle 102 with an example first camera system 104 (or system 104) in accordance with the present disclosure. FIG. 1 will be described in conjunction with FIG. 2, which depicts a cross-sectional view of the system 104.

The vehicle 102 may take the form of any passenger or commercial vehicle such as a car, a work vehicle, a crossover vehicle, a truck, a van, a minivan, a taxi, a bus, etc. The vehicle 102 may be a manually driven vehicle or may be configured to operate in a partially/fully autonomous mode, and may include any powertrain such as a gasoline engine, one or more electrically-actuated motor(s), a hybrid system, etc.

The system 104 may be part of the vehicle 102, and may include a camera 202 that may be configured to capture images of vehicle's surrounding. In some aspects, the camera 202 may be an exterior vehicle camera. The system 104 may be disposed at a vehicle rear portion, a vehicle front portion, a vehicle side portion, and/or the like. Stated another way, the camera 202 may be a rear exterior camera, a front exterior camera, a side camera, and/or the like. Although FIG. 1 depicts the system 104 to be disposed at the vehicle rear portion, the example illustration of FIG. 1 should not be construed as limiting.

The system 104 may further include a housing 106 that may be configured to house or enclose one or more system components (which are described below in the description). In some aspects, the camera 202 may be disposed/housed in the housing 106, as shown in FIG. 2. Specifically, the housing 106 may include a shroud 108, and the camera 202 may be disposed/housed in the shroud 108. In some aspects, the camera 202 may include a lens 110 that may face away from a housing interior portion or a shroud interior portion, as shown in FIGS. 1 and 2. The lens 110 may be configured to gather and focus light rays from vehicle's surroundings that may be falling on the camera 202/lens 110.

As described above, the camera 202 may be configured to capture images of vehicle's surrounding. The images captured by the camera 202 may be displayed to a vehicle driver (not shown) on a user device 112 associated with the driver and/or a vehicle Human-Machine Interface 114 (HMI 114), or may be used by the vehicle 102 to cause/control autonomous vehicle movement. For example, when the system 104 is disposed at the vehicle rear portion, the images captured by the camera 202 may enable the driver to see objects (e.g., other vehicles, obstacles, etc.) that may be present in proximity to the vehicle rear portion, and hence may enable the driver to conveniently move the vehicle 102 backwards (e.g., during reverse vehicle movement). In a similar manner, the images captured by the camera 202 may enable the vehicle 102 to optimally move in left, right or reverse direction, when the vehicle 102 may be moving autonomously.

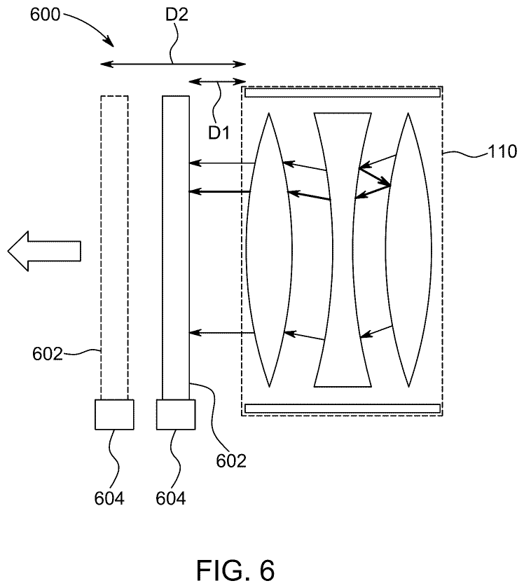

A person ordinarily skilled in the art may appreciate that the images captured by the camera 202 may be of suboptimal quality when the lens 110 may be experiencing glare, e.g., from light rays received from an incoming vehicle, bright sunlight from sun, and/or the like. A glare is characterized as a physical defect of a lens. It is known that the reflective surfaces of the lens cause the light to bounce back and forth between the lens elements. A glare specifically affects cameras where a flange distance (i.e., a distance of a first element of the lens sequence from an imaging sensor, shown as image sensor 602 in FIG. 6) is very small. A glare is prominently formed around bright objects. Typically, there are two ways a glare can affect the image captured by a camera. Examples of these two ways are blooming and smearing.

Blooming is known as the spread of charges to adjacent pixels due to over-saturation of pixels. Blooming typically causes bright spots to appear in the images captured by the camera. Smearing is similar to blooming, and is caused by pixels becoming saturated. In smearing, the light spills over into the vertical shift register while clocking out. Smearing typically causes a vertical line of bright light to appear along a height of the image captured by the camera. Blooming and/or smearing can be typically detected (e.g., by a sensor or a computation device) by identifying local regions in the image captured by the camera with high contrast values, or by looking at clipped areas in the light tone areas of the luminance histogram. In further aspects, a glare in an image can be detected by looking at pixel saturation exceeding a threshold size contiguous.

In the vehicle 102, the glare detection on the lens 110 or on the image captured by the camera 202, as described above, is performed by a sensor unit 116, which may include a plurality of sensors including, but not limited to, photometric sensors, heat detection sensors, and/or the like. Some or all of these sensors may be located in proximity to the camera 202/lens 110.

In some aspects, the system 104 may further include a shield 118 that may be configured to protect or “shield” the lens 110 from glare (i.e., protect the lens 110 from bright light from incoming vehicles or bright sunlight) during a glare event (i.e., when the lens 110 may be experiencing glare). In an exemplary aspect, the shield 118 may be a rectangular plate, as shown in FIGS. 1 and 2. In other aspects (not shown), the shield 118 may be of any other shape, e.g., a concave-shaped plate, a convex-shaped plate, etc.

The shield 118 may be configured to move between a retracted position (shown in view 120 of FIG. 1 and in FIG. 2) and an extended position (shown in view 122 of FIG. 1). The shield 118 may be stowed/disposed inside the housing interior portion when the shield 118 may be in the retracted position, and may extend away from the housing interior portion when the shield 118 may be in the extended position. As shown in FIG. 1, a shield plane (which may be in an X-Y plane) may be perpendicular to a lens plane (which may be in an X-Z plane) when the shield 118 is rectangular. In the exemplary aspect depicted in FIGS. 1 and 2, the shield plane remains perpendicular to the lens plane in both the retracted and extended positions. In this arrangement, the shield 118 may optimally shield/protect the lens 110 from glare when the shield 118 may be in the extended position and when light from incoming vehicles or bright sunlight may be falling on the lens 110.

In some aspects, the vehicle 102 may further include a plurality of additional components/units including, but not limited to, a transceiver 124, a processor 126, a memory 128, the sensor unit 116, the HMI 114, a washer 130 (which may be part of the system 104), a motor 204 (and/or a spinning shaft controlled by the motor 204, which may be part of the system 104), and/or the like, which may be communicatively coupled with each other.

As described above, the sensor unit 116 may include sensors such as photometric sensors, heat detection sensors, and/or the like, which may be configured to detect that the lens 110 may be experiencing glare, and also detect an extent of glare that the lens 110 may be experiencing. In further aspects, the sensor unit 116 may include additional sensors such as rain sensors, ambient weather sensors, moisture sensors, and/or the like, which may be configured to detect a presence of rain and/or snow. In yet another aspects, the sensor unit 116 may be configured to determine a presence of external particles, e.g., dust, debris, mud, etc., in proximity to the system 104 that may impede camera's field of view (FOV).

The motor 204 may be configured to cause a shield movement between the retracted position and the extended position based on command signals received from the processor 126. In some aspects, the motor 204 may be a servo motor or any other type of motor, which may include or be connected with a spinning or rotating shaft (which may be similar to a conventional crankshaft mechanism, not shown). The shaft may be connected to the shield 118 (directly or via a piston). In an exemplary aspect, when the motor 204 receives a command signal from the processor 126, the motor 204 actuates, causing the shaft to rotate/spin. The spinning motion of the shaft may cause the shield to move between the retracted position and the extended position. The exemplary description associated with the motor 204 described above should not be construed as limiting. The motor 204 may cause the shield movement by any other mechanism, without departing from the scope of the present disclosure. In alternative embodiments, the motor may be a solenoid, the actuation of which may cause the shield 118 to move to the extended position.

The washer 130 may be disposed in proximity to the camera 202/lens 110 (as shown in FIG. 1), and may be configured to blow air towards the lens 110 responsive to receiving a washer activation signal from the processor 126. The air from the washer 130 may be used to blow external particles, e.g., dust, debris, mud, etc., that may be present on the lens 110, or dry the lens 110 when the lens 110 may be wet.

The transceiver 124 may be configured to transmit/receive signals/information/data/inputs to/from external devices and systems such as the user device 112, one or more servers (not shown), etc. via a wireless network. The wireless network, as described herein, illustrates an example communication infrastructure in which the connected devices discussed in various embodiments of this disclosure may communicate. The wireless network may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The processor 126 may be in communication with one or more memory devices in communication with the respective computing systems (e.g., the memory 128 and/or one or more external databases not shown in FIG. 1). The processor 126 may utilize the memory 128 to store programs in code and/or to store data for performing aspects in accordance with the disclosure. The memory 128 may be a non-transitory computer-readable storage medium or memory storing a program code that enables the processor 126 to perform operations in accordance with the present disclosure. The memory 128 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In operation, the vehicle driver may provide user inputs via the user device 112 and/or the HMI 114 when the driver desires to move the shield 118 from the retracted position to the extended position (or vice-versa). As an example, the driver may provide the user inputs to move the shield 118 to the extended position when the images captured by the camera 202 (that may be getting displayed on the HMI 114) may be of suboptimal quality and may indicate that the lens 110 may be experiencing glare. Responsive to the driver providing the user inputs, the processor 126 may obtain the user inputs from the user device 112 (via the transceiver 124) and/or the HMI 114, and generate a command signal based on the user inputs. The processor 126 may further transmit the command signal to the motor 204 to cause the shield movement based on the user inputs.

In some aspects, the user inputs may additionally indicate whether the driver desires the shield 118 to be moved fully to the extended position (e.g., to a “fully extended position”, as shown in FIG. 1), or to a partially extended position (e.g., to a position where the shield 118 is 50% or 75% extended). Responsive to receiving such an indication from the driver in the user inputs, the processor 126 may generate the corresponding command signal to cause the motor 204 to move the shield 118 to the fully extended position or a partially extended position based on the user inputs.

In further aspects, the processor 126 may be configured to “learn” the driver's behavior over time as the driver provides the user inputs to the user device 112 and/or the HMI 114 in different weather conditions, vehicle geolocations, time of day, etc., and may use the learning to automatically move the shield 118 to the retracted or extended position in the future. The processor 126 may store information associated with driver's behavior of causing the shield movement in the memory 128, and may use the stored information to enable future shield movements. In some aspects, the processor 126 may store behavior information associated with up to three drivers in the memory 128, and cause the shield movement based on the profile of the driver driving the vehicle 102. In other aspects, the processor 126 may store behavior information associated with less or more than three drivers.

Although the description above describes an aspect where the processor 126 enables the shield movement based on the user inputs, the present disclosure is not limited to such an aspect. In additional or alternative aspects, the processor 126 may cause the shield movement automatically/autonomously based on sensor inputs obtained from the sensor unit 116. In this case, the processor 126 may obtain the sensor inputs from the sensor unit 116, and check/determine whether the extent of glare experienced by the lens 110 may be greater than a predefined threshold based on the sensor inputs. Responsive to determining that the extent of glare may be greater than the predefined threshold, the processor 126 may generate the command signal to move the shield 118 from the retracted position to the extended position, and transmit the command signal to the motor 204. The motor 204 may cause the shield 118 to move to the extended position when the motor 204 receives the command signal from the processor 126, thereby enabling the camera 202 to capture high-quality images (without any glare) of vehicle surroundings. In some aspects, the processor 126 may continue to monitor the extent of glare experienced by the lens 110 based on the sensor inputs, and may generate another command signal to move the shield 118 back to the retracted position when the extent of glare may drop below the predefined threshold. In this manner, the processor 126 may cause automatic to-and-fro shield movement between the retracted position and the extended position based on the extent of glare experienced by the lens 110, thereby considerably enhancing driver's experience of viewing images captured by the camera 202 (or enhancing vehicle's autonomous movement process using “clearer” or high-quality camera images).

In some aspects, the extent of shield movement away from the housing interior portion in the shield extended position may be based on the extent of glare experienced by the lens 110 (above the predefined threshold described above). For example, the processor 126 may cause the shield 118 to move fully to the extended position when the extent of glare may be high, and may cause the shield 118 to move partially to the extended position (e.g., 50% or 75% of the fully extended position) when the extent of glare may be low (but still greater than the predefined threshold).

In further aspects, the processor 126 may be configured to “predict” a predefined time when the lens 110 may experience glare based on information associated with a time of day, weather conditions, real-time and/or expected future vehicle geolocation, vehicle's expected movement direction (e.g., towards or away from sunlight), presence of an incoming vehicle with high beam, and/or the like,, and generate and transmit the command signal to the motor 204 to move the shield 118 to the extended position at the predefined time (or obtain the sensor inputs from the sensor unit 116 at the predefined time). For example, if the weather conditions indicate that there may be bright sunshine between 1 PM to 3 PM on a particular day and the vehicle 102 is expected to move in a direction towards the sunlight, the processor 126 may transmit the command signal to the motor 204 to move the shield 118 to the extended position between 1 PM to 3 PM (or obtain the sensor inputs from the sensor unit 116 between 1 PM to 3 PM).

In some aspects, the shield 118 may be made of a tinted/shaded material or a transparent material with textured surface, so that the shield 118 does not completely block incoming light (thereby impeding camera's FOV), but may just prevent the glare experienced by the lens 110. In an exemplary aspect, the shield 118 may be made of glass that may have a dot matrix, which cuts down on the glare, but still allows some vision through the material. In another aspect, the shield 118 may be made of a material having photosensitive properties, which darkens when sunlight, light from an incoming vehicle and/or glare from the road falls on the shield 118. In yet another aspect, the shield 118 may be made of a transparent material with no photosensitive properties. In this case, the shield 118 may be used to protect the lens 110 from dust, debris, etc.

In further aspects, in addition or alternative to moving the shield 118 between the retracted and extended positions as described above, the processor 126 may cause the camera 202 to move partially/slightly into a shroud interior portion responsive to determining that the extent of glare on the lens 110 may be greater than the predefined threshold or a rain presence in proximity to the vehicle 102 (determined based on the sensor inputs). A person ordinarily skilled in the art may appreciate that when the camera 202 moves partially/slightly into the shroud interior portion, the camera's FOV may not get much affected; however, the glare experienced by the lens 110 may get substantially reduced, thereby enhancing quality of images captured by the camera 202. Further, the partial camera movement into the shroud 108 may help to protect the lens 110 from rainwater, when rain may be detected by the sensor unit 116.

Similar to the aspect associated with the shield 118 described above, the processor 126 may cause the camera 202 to move back to its default position from the shroud interior portion when the extent of glare on the lens 110 may drop below the predefined threshold or the rain may stop.

To further enhance driver's convenience or vehicle's autonomous movement process, the processor 126 may determine presence of external particles, e.g., dust, debris, mud, etc., in proximity to the lens 110 based on the sensor inputs, and transmit the washer activation signal to the washer 130 when external particles may be detected on or in proximity to the lens 110. The processor 126 may further generate and transmit the washer activation signal to the washer 130 when the processor 126 determines that the lens 110 may be wet or smeared with water (determined via the sensor inputs). Responsive to receiving the washer activation signal from the processor 126, the washer 130 may blow air towards the lens 110 (and substantially parallel to the lens plane), which may remove the external particles from the lens 110 or dry the lens 110, thereby enabling the camera 202 to capture clearer/high quality images.

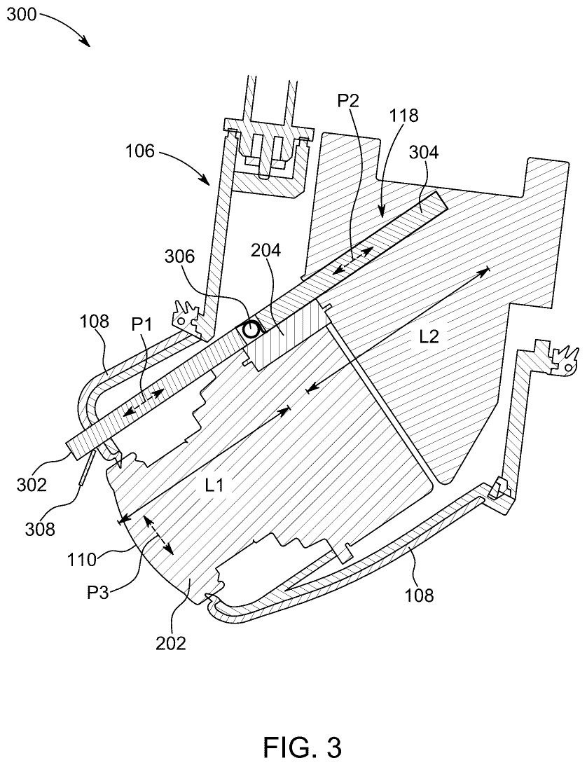

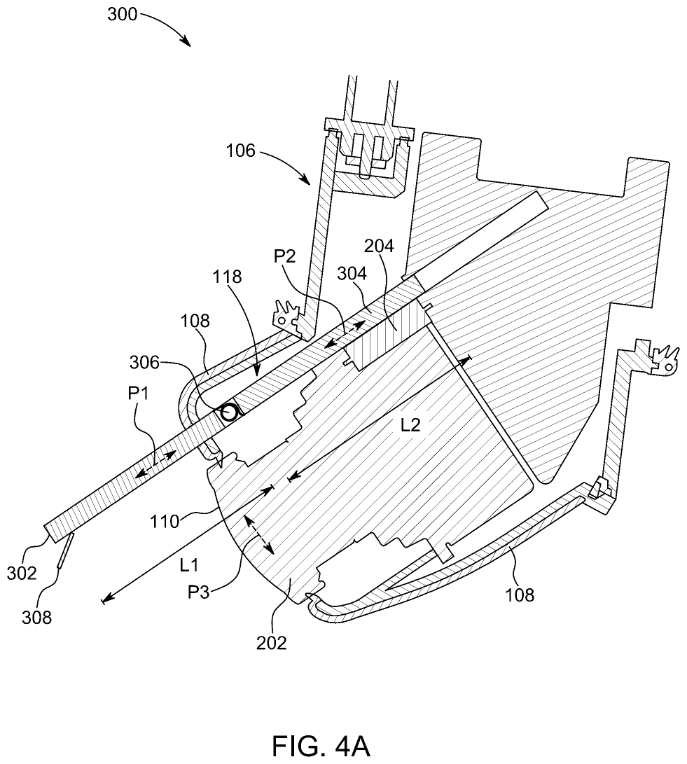

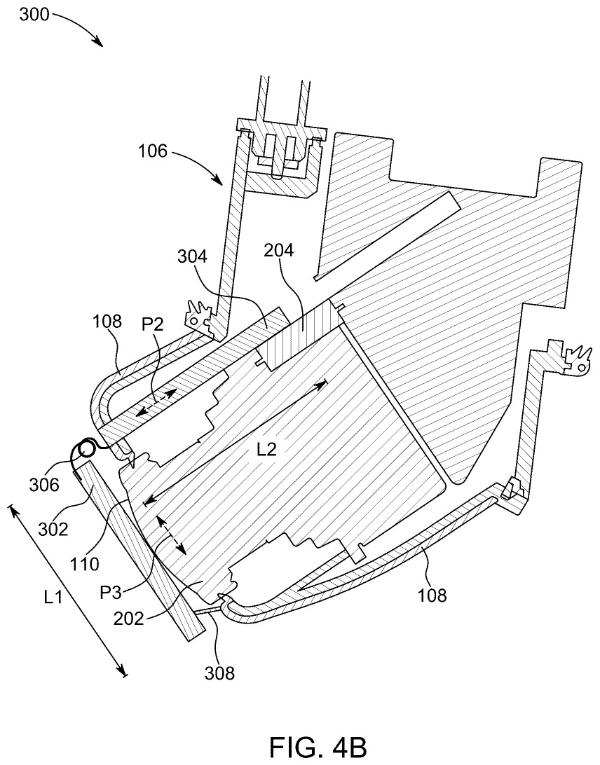

FIG. 3 depicts a cross-sectional view of a second camera system 300 (or system 300) in accordance with the present disclosure. FIG. 3 will be described in conjunction with FIGS. 4A and 4B.

The system 300 may be similar to the system 104 described above; however, instead of having a single piece shield (as described above in conjunction with FIGS. 1 and 2), the shield 118 of the system 300 may include two pieces/portions, i.e., a first portion 302 and a second portion 304. A first portion length “L1” may be equivalent to or different from a second portion length “L2”. The length “L1” may at least be enough to fully cover the lens 110 when the shield 118 may be in the fully extended position (as described below in detail).

As shown in FIGS. 3, 4A and 4B, the first portion 302 may be connected to the second portion 304 via a hinge and spring connection 306 (or hinge 306). The first portion 302 may be configured to pivotally rotate relative to the second portion 304 via the hinge 306. A view of the first portion 302 being rotated by 90 degrees relative to the second portion 304 is shown in FIG. 4B.

In some aspects, the shield 118 of the system 300 may be configured to move between a retracted position (as shown in FIG. 3), a partially extended position (as shown in FIG. 4A), and a fully extended position (as shown in FIG. 4B). The first portion 302 and the second portion 304 may be completely disposed inside the housing interior portion when the shield 118 may be in the retracted position. Further, a first portion plane “P1” may be parallel to a second portion “P2”, and perpendicular to a lens plane “P3”, when the shield 118 may be in the retracted position, as shown in FIG. 3.

The first portion 302 may extend away from the housing interior portion and the second portion 304 may stay inside the housing interior portion when the shield 118 may be moved to the partially extended position or the fully extended position. The shield movement from the retracted position to the partially extended position or the fully extended position (and back to the retracted position) may be enabled/controlled by the motor 204, as described above in conjunction with FIGS. 1 and 2.

As shown in FIG. 4A, the first portion 302 may not rotate relative to the second portion 304, and the first portion plane “P1” may remain perpendicular to the lens plane “P3” when the shield 118 may be in the partially extended position. In this arrangement, the first portion 302 may shield the lens 110 from glare, as described above in conjunction with FIGS. 1 and 2.

As shown in FIG. 4B, the first portion 302 may rotate relative to the second portion 304 via the hinge 306, and the first portion plane “P1” may become parallel to the lens plane “P3” when the shield 118 may be moved to the fully extended position. In this case, the first portion 302 may automatically rotate relative to the second portion 304 via the hinge 306 (or “swing down”) under the force of gravity when the first portion 302 completely crosses the shroud edge (and is disposed completely out of the housing interior portion). In the fully extended position, the first portion 302 may completely cover the lens 110 from the front, thereby protecting the lens 110 from external particles such as mud, dirt, debris, etc.

During operation, the processor 126 may generate a first command signal to move the shield 118 to the partially extended position when the processor 126 determines that the extent of glare experienced by the lens 110 may be greater than the predefined threshold based on the sensor inputs. Responsive to generating the first command signal, the processor 126 may transmit the first command signal to the motor 204, which may cause the shield movement to the partially extended position when the motor 204 receives the first command signal from the processor 126. In the partially extended position, the first portion 302/shield 118 acts as a sun shade.

In further aspects, the processor 126 may generate a second command signal to move the shield 118 to the fully extended position when the processor 126 detects presence of external particles (mud, dirt, debris, etc.) in proximity to the camera 202 based on the sensor inputs. Responsive to generating the second command signal, the processor 126 may transmit the second command signal to the motor 204, which may cause the shield movement to the fully extended position when the motor 204 receives the second command signal from the processor 126. In the fully extended position, the first portion 302/shield 118 protects the lens 110/camera 202 from the external particles, thereby facilitating in keeping the camera 202 clean.

In additional aspects, the processor 126 may be configured to generate the second command signal and cause the shield 118 to move to the fully extended position when the vehicle 102 operates in a predefined operation mode (e.g., an off-road mode). In this case, responsive to determining that the vehicle 102 may be operating in the off-road mode, the processor 126 may automatically generate the second command signal, and transmit the second command signal to the motor 204, which may cause the shield movement to the fully extended position responsive to receiving the second command signal. In the fully extended position, the first portion 302/shield 118 may protect the lens 110/camera 202 from stone chirps, mud, etc. that may fall on the lens 110/camera 202 when the vehicle 102 is driven off-road.

In some aspects, the system 300 may further include a seal 308 that may be disposed at a bottom surface of a first portion distal end. The seal 308 may act as a positive stop when the shield 118 may be moved back to the retracted position (from the partially or fully extended positions), preventing the first portion distal end to get completely inserted or moved into the housing interior portion.

Remaining system 300 components are same as system 104 components, and hence are not described again here for the sake of simplicity and conciseness.

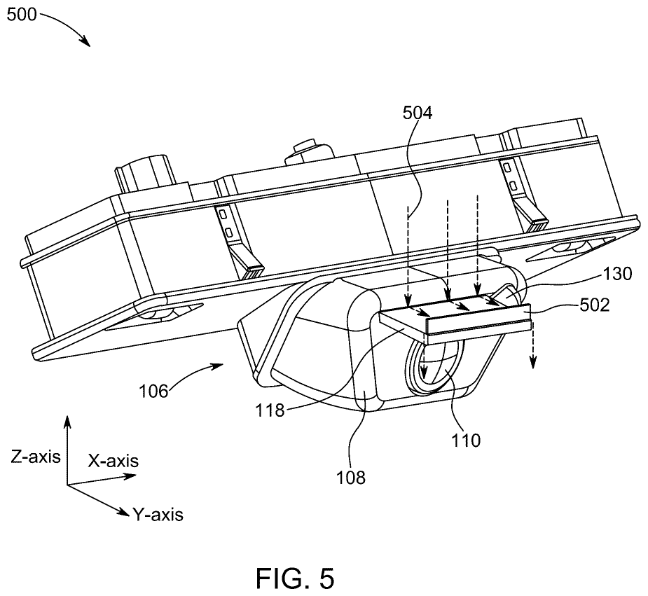

FIG. 5 depicts an isometric view of a third camera system 500 (or system 500) in accordance with the present disclosure. FIG. 5 specifically depicts a view of the system 500 where the shield 118 is in the extended position.

The system 500 may be similar to the system 104; however, the shield 118 may additionally include a gutter structure 502 that may be disposed at a shield distal end/edge. In some aspects, a gutter structure length may be equivalent to a shield width. Further, a gutter structure plane (which may in the X-Z plane, as shown in FIG. 5) may be perpendicular to the shield plane (which may in the X-Y plane) and parallel or substantially parallel to the lens plane.

The gutter structure 502 may be configured to protect the lens from rain water 504 when the shield 118 may be in the extended position, as shown in FIG. 5. Specifically, the rain water 504 may fall off the side edges of the shield 118 and not from the shield distal edge, thereby protecting the lens 110 from the rain water 504 and ensuring that the camera's FOV is not obstructed by the rain water 504.

In this case, in addition to moving the shield 118 to the extended position when the extent of glare on the lens 110 may be greater than the predefined threshold (as described above), the processor 126 may generate and transmit the command signal to the motor 204 to cause the shield movement to the extended position when the processor 126 detects presence of rain based on the sensor inputs obtained from the sensor unit 116. The processor 126 may further cause the shield 118 to move back to the retracted position when the rain stops.

Remaining system 500 components are same as the system 104 components, and hence are not described again here for the sake of simplicity and conciseness.

Although the description above describes systems and methods to prevent camera lens from experiencing glare, the present disclosure is not limited to such an aspect. Same or similar systems and methods may be applied to vehicle mirrors (e.g., rear view side mirrors), when the mirrors may be experiencing glare.

FIG. 6 depicts a schematic of a vehicle camera 600 in accordance with the present disclosure. The camera 600 may be same as the camera 202 described above, and may include the lens 110 and an imaging sensor or an image sensor 602. The image sensor 602 may be disposed at a first predefined distance “D1” away from the lens 110 in the camera's default position.

Although the description above describes aspects where the processor 126 moves the shield 118 from the retracted position to the extended position when the extent of glare at the lens 110 is greater than the predefined threshold, the present disclosure is not limited to such an aspect. In additional or alternative aspects, the processor 126 may cause the image sensor 602 to move a second predefined distance “D2” away from the lens 110, responsive to determining that the extent of glare on the lens 110 may be greater than the predefined threshold. The distance “D2” may be greater than the distance “D1”, and may be based on the extent of glare on the lens 110 and/or camera structure/dimensions. A person ordinarily skilled in the art may appreciate that the glare in the image captured by the camera 600 may be significantly reduced when the distance between the image sensor 602 and the lens 110 is increased. The processor 126 may cause the image sensor 602 to move back to its default position (i.e., when the distance between the image sensor 602 and the lens 110 is “D1”) when the extent of glare may reduce below the predefined threshold.

In an exemplary aspect, the image sensor 602 may be mounted on a piezo actuator 604, as shown in FIG. 6. The processor 126 may cause the image sensor movement, as described above, by transmitting a command signal to the piezo actuator 604, and activating the piezo actuator 604. Responsive to the piezo actuator 604 being activated, the piezo actuator 604 may move the image sensor 602 away from or close to the lens 110, based on the command signal received from the processor 126. In this manner, the processor 126 may assist in reducing the glare at the lens 110, in addition or alternative to using the shield 118.

The vehicle 102 and/or the vehicle driver implement and/or perform operations, as described here in the present disclosure, in accordance with the owner manual and safety guidelines. In addition, any action taken by the driver based on notifications/signals provided by the vehicle 102 should comply with all the rules specific to the location and operation of the vehicle 102 (e.g., Federal, state, country, city, etc.). The notifications/signals, as provided by the vehicle 102, should be treated as suggestions and only followed according to any rules specific to the location and operation of the vehicle 102.

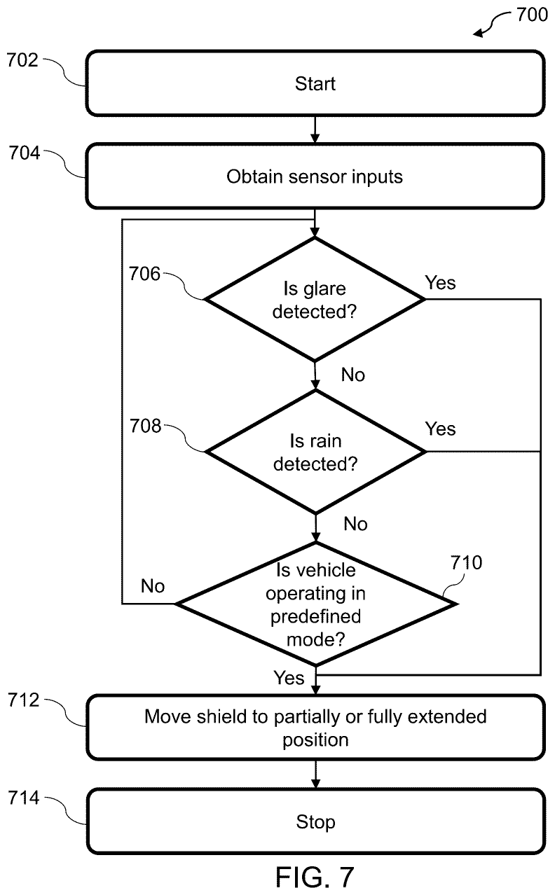

FIG. 7 depicts a flow diagram of an example method 700 to shield a vehicle camera in accordance with the present disclosure. FIG. 7 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 700 starts at step 702. At step 704, the method 700 may include obtaining, by the processor 126, the sensor inputs from the sensor unit 116. The processor 126 may obtain the sensor inputs at the predefined time described above, or continuously from the sensor unit 116. At step 706, the method 700 may include determining, by the processor 126, whether glare is detected at the lens 110 based on the sensor inputs. Responsive to detecting glare at the lens 110, the method 700 moves to step 712, at which the shield 118 is moved to the partially extended position or the fully extended position based on the extent of glare detected at the lens 110.

On the other hand, responsive to not detecting glare at the lens 110 at the step 706, the method 700 may move to step 708, at which the processor 126 may determine/detect a presence of rain based on the sensor inputs. Responsive to detecting the rain presence, the method 700 may move to the step 712 described above. On the other hand, responsive to not detecting rain at the step 708, the method 700 may move to step 710, at which the processor 126 may determine whether the vehicle 102 may be operating in the predefined operation mode/off-road mode.

Responsive to determining that the vehicle 102 is not operating in the predefined operation mode/off-road mode, the method 700 may return to the step 706. On the other hand, response to determining that the vehicle 102 is operating in the predefined operation mode/off-road mode, the method 700 may move to the step 712.

At step 714, the method 700 may end.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a housing;
a camera disposed in the housing, wherein the camera comprises a lens that faces away from a housing interior portion; and
a shield configured to move between a retracted position and an extended position, wherein:
the shield shields the lens from glare in the extended position, and does not shield the lens in the retracted position,
the shield comprises a gutter structure disposed at a shield distal end, and
a gutter structure plane is perpendicular to a shield plane.

2. The vehicle of claim 1, wherein the gutter structure is configured to protect the lens from rain water in the extended position.

3. The vehicle of claim 1, wherein the shield is a rectangular plate, and wherein the shield plane is perpendicular to a lens plane in the retracted position and the extended position.

4. The vehicle of claim 1 further comprising a processor and a motor, wherein the motor is configured to cause a shield movement between the retracted position and the extended position based on a command signal received from the processor.

5. The vehicle of claim 4, wherein the processor is configured to:
obtain user inputs via a user device or a vehicle Human-Machine Interface (HMI) to cause the shield movement;
generate the command signal based on the user inputs; and
transmit the command signal to the motor.

6. The vehicle of claim 4 further comprising a sensor unit configured to detect an extent of glare on the lens or a rain presence, and wherein the processor is configured to:
obtain sensor inputs from the sensor unit;
determine that the extent of glare on the lens is greater than a predefined threshold or the rain presence based on the sensor inputs;
generate the command signal to move the shield from the retracted position to the extended position responsive to determining that the extent of glare on the lens is greater than the predefined threshold or the rain presence; and
transmit the command signal to the motor.

7. The vehicle of claim 6, wherein the camera further comprises an image sensor disposed at a first predefined distance from the lens, and wherein the processor is further configured to cause the image sensor to move a second predefined distance away from the lens responsive to determining that the extent of glare on the lens is greater than the predefined threshold.

8. The vehicle of claim 7, wherein the image sensor is mounted on a piezo actuator, and wherein the processor activates the piezo actuator to cause the image sensor to move the second predefined distance away from the lens responsive to determining that the extent of glare on the lens is greater than the predefined threshold.

9. The vehicle of claim 4, wherein the shield comprises a first portion and a second portion, wherein the first portion and the second portion are connected to each other via a hinge, and wherein the first portion is configured to pivotally rotate relative to the second portion via the hinge.

10. The vehicle of claim 9, wherein the extended position comprises a partially extended position and a fully extended position, and wherein the first portion is configured to extend away from a housing interior portion and the second portion is configured to stay inside the housing interior portion when the shield moves to the fully extended position or the partially extended position.

11. The vehicle of claim 10, wherein the first portion does not rotate relative to the second portion and a first portion plane is perpendicular to a lens plane when the shield is in the partially extended position, and wherein the first portion rotates relative to the second portion and the first portion plane is parallel to the lens plane when the shield is in the fully extended position.

12. The vehicle of claim 11, wherein the processor is configured to:
detect a presence of external particles in proximity to the camera based on sensor inputs obtained from a sensor unit;
generate the command signal to move the shield to the fully extended position responsive to determining the presence of external particles; and
transmit the command signal to the motor.

13. The vehicle of claim 11, wherein the processor is configured to:
determine that the vehicle is operating in a predefined operation mode;
generate the command signal to move the shield to the fully extended position responsive to determining that the vehicle is operating in the predefined operation mode; and
transmit the command signal to the motor.

14. The vehicle of claim 4 further comprising a washer disposed in proximity to the camera, wherein the washer is configured to blow air towards the lens based on a washer activation signal obtained from the processor.

15. The vehicle of claim 4, wherein the housing comprises a shroud, wherein the camera is disposed in the shroud, and wherein the processor is configured to cause the camera to move into a shroud interior portion responsive to determining that an extent of glare on the lens is greater than a predefined threshold or a rain presence.

16. The vehicle of claim 4, wherein the processor is configured to:
predict a glare on the lens at a predefined time based on information associated with at least one of a time of day, weather conditions or a vehicle geolocation;
generate the command signal at the predefined time; and
transmit the command signal to the motor.

17. The vehicle of claim 1, wherein the shield is made of a tinted material, a transparent material with textured surface or a material with photosensitive properties.

18. A vehicle comprising:
a housing;
a camera disposed in the housing, wherein the camera comprises a lens that faces away from a housing interior portion; and
a shield configured to move between a retracted position, a partially extended position and a fully extended position, wherein:
the shield comprises a first portion and a second portion,
the first portion and the second portion are connected to each other via a hinge,
the first portion is configured to pivotally rotate relative to the second portion via the hinge,
the first portion does not rotate relative to the second portion and a first portion plane is perpendicular to a lens plane when the shield is in the partially extended position, and
the first portion rotates relative to the second portion and the first portion plane is parallel to the lens plane when the shield is in the fully extended position.

19. The vehicle of claim 18, wherein the first portion is configured to extend away from the housing interior portion and the second portion is configured to stay inside the housing interior portion when the shield moves to the fully extended position or the partially extended position, and wherein the shield is stowed inside the housing interior portion in the retracted position.

20. A method comprising:
obtaining, by a processor, sensor inputs from a sensor unit associated with a vehicle, wherein the sensor unit is configured to detect an extent of glare on a lens associated with a camera or a rain presence, wherein the vehicle comprises:
a housing;
the camera disposed in the housing, wherein the lens faces away from a housing interior portion; and
a shield configured to move between a retracted position and an extended position, wherein:
the shield shields the lens from glare in the extended position and does not shield the lens in the retracted position,
the shield comprises a gutter structure disposed at a shield distal end, and
a gutter structure plane is perpendicular to a shield plane;
determining, by the processor, that the extent of glare on the lens is greater than a predefined threshold or the rain presence based on the sensor inputs;
generating, by the processor, a command signal to move the shield from the retracted position to the extended position responsive to determining that the extent of glare on the lens is greater than the predefined threshold or the rain presence; and
transmitting, by the processor, the command signal to a motor associated with the vehicle, wherein the motor is configured to cause a shield movement between the retracted position and the extended position based on the command signal received from the processor.
